(19) United States
(12) Patent Application Publication
(10) Pub. No.: US 2012/0062644 A1
(43) Pub. Date: Mar. 15, 2012

(54) AQUEOUS INKJET INK

(75) Inventors: Takafumi Hara, Shizuoka-ken (JP); Ryozo Akiyama, Shizuoka-ken (JP); Maiko Yoshida, Shizuoka-ken (JP); Chie Tonohiro, Shizuoka-ken (JP); Atsushi Kubota, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/223,728

(22) Filed: Sep. 1, 2011

Related U.S. Application Data
(60) Provisional application No. 61/381,133, filed on Sep. 9, 2010.

(51) Int. Cl. B41J 2/015; C09D 11/02

(52) U.S. Cl. 347/20; 106/31.13; 106/31.86

(57) ABSTRACT

According to one embodiment, an aqueous inkjet ink includes a color material, water in an amount of 50-70% by mass of the total amount of the ink, and a water-soluble organic solvent in an amount of 29-49% by mass of the total amount. The soluble organic solvent contains a compound represented by the following general formula 1 which accounts for 10-36% by mass of the total amount of ink. When the amount of the compound is equal to the amount of the solvent, the total amount of the solvent is the compound. The sum of the amounts of the color material, the water, and the water-soluble organic solvent is 100% by mass or less of the ink.

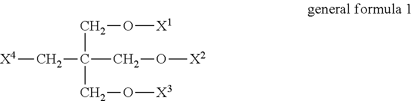

Where, X¹, X², and X³ each independently represent EOn, and X⁴ represents an CH₃CH₂— or an (EOn)O—. EOn is represented by the following general formula 2, where n representing an integer of 1-5.

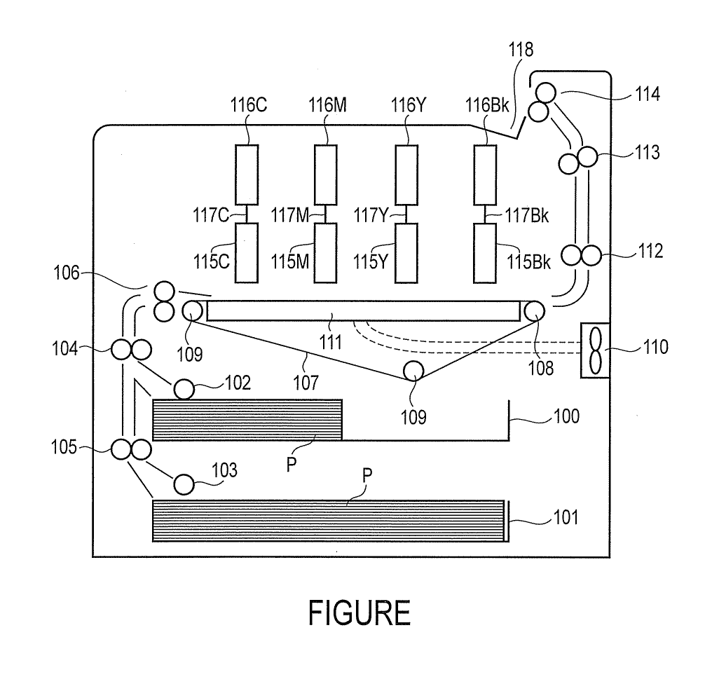

CH₂—CH₂ₙOH general formula 2

### CROSS-REFERENCE TO RELATED APPLICATIONS

This application is based upon and claims the benefit of priority from U.S. Provisional Application No. 61/381,133 filed on Sep. 9, 2010, the entire contents of which are incorporated herein by reference.

### FIELD

Embodiments described herein relate generally to an aqueous inkjet ink, a method for inkjet printing, and an inkjet printing apparatus.

### BACKGROUND

In an aqueous inkjet ink, a color material such as a dye or a pigment is dispersed in an aqueous medium.

Even when an aqueous medium having high volatility such as water is used, an aqueous inkjet ink should have a property suitable for ejection from an inkjet head. Further, the aqueous inkjet ink for use in printing on a paper medium is required to prevent the deformation of a paper medium such as curling or cockling.

### BRIEF DESCRIPTION OF THE DRAWINGS

The single FIGURE shows an example of an inkjet printing apparatus to which an embodiment is applied.

### DETAILED DESCRIPTION

In general, according to one embodiment, an aqueous inkjet ink includes a color material, water in an amount of from 50 to 70% by mass of the total amount of the ink, and a water-soluble organic solvent in an amount of from 29 to 49% by mass of the total amount of the ink. The water-soluble organic solvent contains a compound represented by the following general formula 1, and the compound represented by the following general formula 1 accounts for 10 to 36% by mass of the total amount of the ink. When the amount of the compound represented by the following general formula 1 is equal to the amount of the water-soluble organic solvent, the total amount of the water-soluble organic solvent is composed of the compound represented by the following general formula 1. The sum of the amounts of the color material, the water, and the water-soluble organic solvent is 100% by mass or less of the ink.

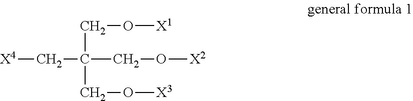

In the general formula 1, X¹, X², and X³ each independently represent EOn, and X⁴ represents an ethyl group or an (EOn)O group, wherein EOn is represented by the following general formula 2.

CH₂—CH₂ₙOH general formula 2

In the general formula 2, n represents an integer of 1 to 5.

Hereinafter, embodiments will be specifically described.

In an inkjet printing apparatus shown in the FIGURE, paper cassettes 100 and 101 contain paper P of different sizes, respectively. A paper feed roller 102 or 103 takes out the paper P in response to the selected paper size from the paper cassette 100 or 101 and conveys the paper P to conveying roller pairs 104 and 105 and a resist roller pair 106.

A tension is given to a conveying belt 107 by a driving roller 108 and two driven rollers 109. Through-holes are provided at predetermined intervals in the conveying belt 107, and for the purpose of adsorbing the paper P onto the conveying belt 107, a negative pressure chamber 111 connected to a fan 110 is installed in the inside of the conveying belt 107. Conveying roller pairs 112, 113, and 114 are installed downstream in the paper conveying direction of the conveying belt 107. A conveying unit is constituted by the conveying belt 107, the driving roller 108, the driven rollers 109, and the conveying roller pairs 112, 113, and 114.

Four rows of inkjet heads which eject inks onto paper according to image data are disposed above the conveying belt 107. An inkjet head 115C which ejects a cyan (C) ink, an inkjet head 115M which ejects a magenta (M) ink, an inkjet head 115Y which ejects a yellow (Y) ink, and an inkjet head 115Bk which ejects a black (Bk) ink are arranged in this order from the upstream. Further, these inkjet heads 115C, 115M, 115Y, and 115Bk are provided with a cyan (C) ink cartridge 116C, a magenta (M) ink cartridge 116M, a yellow (Y) ink cartridge 116Y, and a black (Bk) ink cartridge 116Bk, respectively, each of which contains an ink of each color. These cartridges are connected to the inkjet heads via tubes 117C, 117M, 117Y, and 117Bk, respectively.

An image forming action of the inkjet printing apparatus having such a structure will be described below.

First, image processing for printing by an image processing unit (not shown) is initiated, and image data for printing are transferred to the respective inkjet heads 115C, 115M, 115Y, and 115Bk. Also, the paper P (paper medium P) of a selected paper size is taken out one by one from the paper cassette 100 or 101 by the paper feed roller 102 or 103 and conveyed to the conveying roller pairs 104 and 105 and the resist roller pair 106. The resist roller pair 106 corrects a skew of the paper P and conveys the paper P to each of the inkjet heads 115C, 115M, 115Y, and 115Bk at a given timing.

In general, the paper P is conveyed at a speed less than 50 ppm (page per minute). It is said that if the conveying speed not less than 50 ppm, a paper jam is liable to occur.

The negative pressure chamber 111 draws air through the holes of the conveying belt 107, and therefore, the paper P is conveyed in a state of being adsorbed onto the conveying belt 107 on a lower side of the inkjet heads 115C, 115M, 115Y, and 115Bk. In this manner, the respective inkjet heads 115C, 115M, 115Y, and 115Bk and the paper P can keep a fixed space from each other. The ink of each color is ejected from each of the inkjet heads 115C, 115M, 115Y, and 115Bk in synchronization with the timing for conveying the paper P from the resist roller pair 106. Thus, a color image is formed at a desired position on the paper P. The paper P having an image formed thereon is discharged to a paper discharge tray 118 by the conveying roller pairs 112, 113, and 114.

Each ink cartridge stores an aqueous inkjet ink according to one embodiment.

The aqueous inkjet ink according to this embodiment contains water, a water-soluble organic solvent, and a color material. The amount of water is from 50 to 70% by mass of the total amount of the ink, and the amount of the water-soluble organic solvent is from 29 to 49% by mass of the total amount of the ink. Further, the water-soluble organic solvent contains a glycol ether represented by the following general formula 1, and the glycol ether accounts for 10 to 36% by mass of the total amount of the ink.

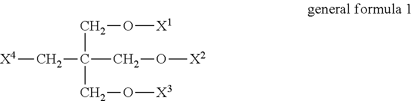

In the general formula 1, X¹, X², and X³ each independently represent EOn, and X⁴ represents an ethyl group or an (EOn)O group, wherein EOn is represented by the following general formula 2.

CH₂—CH₂ₙOH general formula 2

In the general formula 2, n represents an integer of 1 to 5.

An ink medium in the aqueous inkjet ink according to this embodiment is composed of water and a water-soluble organic solvent containing a given glycol ether, both of which are blended in predetermined amounts, respectively. In the ink medium, a color material is dissolved or dispersed. As described above, the amount of water is from 50 to 70% by mass of the total amount of the ink, and the amount of the water-soluble organic solvent is from 29 to 49% by mass of the total amount of the ink. Further, the glycol ether represented by the above general formula 1 accounts for 10 to 36% by mass of the total amount of the ink. Since such an ink medium is used, the aqueous inkjet ink according to this embodiment can form a high-quality image on a paper medium while suppressing the deformation of the paper medium as much as possible.

The aqueous inkjet ink according to this embodiment has an excellent ability to suppress the deformation of paper, and therefore, there is no fear that paper after printing cannot be conveyed. As a result, it became possible to use the aqueous inkjet ink in high-speed printing at a printing speed of 50 ppm or more.

The paper medium as used herein generally refers to a medium made of paper to be used for printing. The paper medium is broadly divided into coated paper coated with a material for increasing print properties such as art paper or coat paper and non-coated paper to be used for utilizing the properties of paper itself. The paper medium is applied to a variety of uses such as books, documents, newspapers, packages, printer sheets, etc. The paper medium also includes corrugated cardboard, containers made of paper, and thick paper such as cardboard. For example, so-called plain paper such as copy paper to be used in a copier or a printer for office or home use is a typical paper medium.

According to one embodiment, a color material is contained in an ink medium which includes water and a water-soluble organic solvent containing a given glycol ether in predetermined amounts, respectively.

As the color material, either of a dye and a pigment may be used. As the dye, any of a variety of dyes to be used in an inkjet ink such as a direct dye, an acidic dye, a food dye, a reactive dye, or a disperse dye can be used.

Specific examples of the dye include the following dyes: C.I. Direct Yellow 8, C.I. Direct Yellow 11, C.I. Direct Yellow 24, C.I. Direct Yellow 26, C.I. Direct Yellow 27, C.I. Direct Yellow 28, C.I. Direct Yellow 33, C.I. Direct Yellow 44, C.I. Direct Yellow 50, C.I. Direct Orange 6, C.I. Direct Orange 8, C.I. Direct Orange 29, C.I. Direct Orange 102, C.I. Direct Red 1, C.I. Direct Red 2, C.I. Direct Red 4, C.I. Direct Red 13, C.I. Direct Red 17, C.I. Direct Red 20, C.I. Direct Red 33, C.I. Direct Red 37, C.I. Direct Red 44, C.I. Direct Red 46, C.I. Direct Red 62, C.I. Direct Red 75, C.I. Direct Blue 1, C.I. Direct Blue 2, C.I. Direct Blue 6, C.I. Direct Blue 15, C.I. Direct Blue 22, C.I. Direct Blue 25, C.I. Direct Blue 76, C.I. Direct Blue 77, C.I. Direct Blue 86, C.I. Direct Blue 108, and C.I. Direct Blue 120.

The dye is preferably contained in the ink in an amount of from 1 to 20% by mass of the total amount of the ink. If the dye is contained within this range, a printed matter having a necessary image density can be formed without causing any problems with respect to the storage stability or ejection performance of the ink.

If a pigment is used as the color material, the water resistance and light resistance of the aqueous inkjet ink can be further increased.

The pigment is not particularly limited, and either of an inorganic pigment and an organic pigment may be used. Examples of the inorganic pigment include titanium oxide and iron oxide. Further, a carbon black produced by a known method such as a contact method, a furnace method, or a thermal method can be used.

As the organic pigment, for example, an azo pigment (such as an azo lake pigment, an insoluble azo pigment, a condensed azo pigment, or a chelate azo pigment), a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a dye chelate (such as a basic dye type chelate, or an acid dye type chelate), a nitro pigment, a nitroso pigment, aniline black, or the like can be used.

Specific examples of the carbon black which is used in a black ink include No. 2300, No. 900, MCF88, No. 33, No. 40, No. 45, No. 52, MA7, MA8, MA100, and No. 2200B (all of which are manufactured by Mitsubishi Chemical Corporation), Raven 5750, Raven 5250, Raven 5000, Raven 3500, Raven 1255, and Raven 700 (all of which are manufactured by Columbian Chemicals Company), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of which are manufactured by Cabot Corporation), and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all of which are manufactured by Degussa AG).

Specific examples of the pigment which is used in a yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Specific examples of the pigment which is used in a magenta ink include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, and C.I. Pigment Violet 19.

Specific examples of the pigment which is used in a cyan ink include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Vat Blue 4, and C.I. Vat Blue 60.

Since the pigment is used in an inkjet ink, it is preferred that the average particle diameter of the pigment is within a range of from about 10 to 300 nm. It is more preferred that the average particle diameter of the pigment is within a range of from about 10 to 200 nm.

The average particle diameter of the pigment can be determined using a particle size distribution analyzer by means of a dynamic light scattering method. Examples of the particle size distribution analyzer include HPPS (Malvern Instruments Ltd.).

The pigment can be used in a state of a pigment dispersion. The pigment dispersion can be prepared by, for example, dispersing the pigment in water or an alcohol with a dispersant. Examples of the dispersant include a surfactant, a water-soluble resin, and a water-insoluble resin. Alternatively, a self-dispersible pigment may be used. The self-dispersible pigment is a pigment which can be dispersed in water or the like without using a dispersant, and to which at least one functional group selected from a carbonyl group, a carboxyl group, a hydroxyl group, and a sulfone group or a salt thereof is bound through a surface treatment. Examples of the surface treatment include a vacuum plasma treatment, a diazo coupling treatment, and an oxidation treatment. The self-dispersible pigment is obtained by grafting a functional group or a molecule containing a functional group on the surface of a pigment through such a surface treatment.

The amount of the pigment in the ink is preferably within a range of from 1 to 20% by mass of the total amount of the ink. If the amount of the pigment is within this range, a printed matter having a necessary image density can be formed without causing any problems with respect to the storage stability or ejection performance of the ink. An ink containing the pigment in an amount of from 2 to 10% by mass of the total amount of the ink has a viscosity suitable for ejection from an inkjet head over a wide temperature range of from about 20 to 50° C. Also, the quality of an image formed using the ink is favorable.

The pigment dispersion is mixed with the ink medium composed of water and a water-soluble organic solvent containing a given glycol ether, whereby the aqueous inkjet ink according to this embodiment is obtained.

As described above, according to one embodiment, the amount of water is from 50 to 70% by mass of the total amount of the ink. If the amount of water in the ink is too small, a viscosity within a range suitable as an inkjet ink cannot be ensured, and therefore, the ejection performance from the inkjet head is lowered. Moreover, the dispersion stability of the pigment is lowered, and therefore, the clogging of the inkjet head is liable to occur. On the other hand, if the amount of water in the ink is too large, it is not easy to suppress the deformation of paper. The amount of water is preferably from 50 to 65% by mass of the total amount of the ink.

In the aqueous inkjet ink according to one embodiment, from 29 to 49% by mass of the total amount of the ink is the water-soluble organic solvent. If the amount of the water-soluble organic solvent in the ink is too small, it is not easy to suppress the deformation of paper. On the other hand, if the amount of the water-soluble organic solvent in the ink is too large, a viscosity within a range suitable as an inkjet ink cannot be ensured, and therefore, the ejection performance from the inkjet head is lowered. Moreover, the dispersion stability of the pigment is lowered, and therefore, the clogging of the inkjet head is liable to occur. The amount of the water-soluble organic solvent is more preferably from 35 to 49% by mass of the total amount of the ink. The sum of the amounts of the color material, water, and the water-soluble organic solvent is 100% by mass or less of the aqueous inkjet ink.

In the water-soluble organic solvent, a glycol ether represented by the following general formula 1 is contained. The amount of the glycol ether is from 10 to 36% by mass of the total amount of the ink.

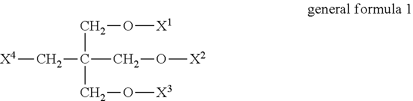

In the general formula 1, X¹, X², and X³ each independently represent EOn, and X⁴ represents an ethyl group or an (EOn)O group. EOn is represented by the following general formula 2.

CH₂—CH₂ₙOH general formula 2

In the general formula 2, n represents an integer of 1 to 5.

The glycol ether represented by the general formula 1 is generally referred to as polyoxyethylene trimethylol propane ether and polyoxyethylene pentaerythritol ether. Examples of the polyoxyethylene trimethylol propane ether include TMP-30, TMP-60, and TMP-90 (all of which are manufactured by Nippon Nyukazai Co., Ltd.). Further, examples of the polyoxyethylene pentaerythritol ether include PNT-40 and PNT-60U (both of which are manufactured by Nippon Nyukazai Co., Ltd.).

If the inkjet ink includes an ink medium containing a glycol ether as described above, a suppressive effect of the ink on the deformation of paper is high. The present inventors considered the suppression of deformation of paper as follows. When paper comes into contact with the aqueous ink, the paper is deformed generally due to a mechanism as described below. First, because of water in the aqueous ink, hydrogen atoms forming hydrogen bonds in cellulose fiber which is a main component of paper are dissociated due to swelling and the hydrogen bonds are cleaved. When water evaporates and the paper dries, the hydrogen atoms in the cellulose fiber are reassociated and form hydrogen bonds again. This reassociation occurs in different states or at different positions than before the hydrogen bonds are cleaved, and as a result, the paper is deformed and curling or the like is caused.

The glycol ether represented by the general formula 1 contains ethylene oxide groups at symmetrical positions. These ethylene oxide groups can reassociate hydrogen atoms and form again hydrogen bonds which were cleaved by the penetration of water molecules. In this manner, the deformation of paper is suppressed.

By using the ink medium including the water-soluble organic solvent containing such a glycol ether and water in combination, the excellent properties thereof is maximally exhibited, and the performance of suppressing the deformation of paper is markedly improved.

Moreover, the aqueous inkjet ink according to this embodiment also has excellent ejection performance from the inkjet head. An inkjet head member is generally made of a resin subjected to an insulation treatment, and also an inside portion of an ink supply channel is generally made of a rubber or a resin. The above-mentioned glycol ether has relatively favorable wettability to such a material, and therefore, the ejection performance from the inkjet head can be increased.

The amount of the glycol ether represented by the above general formula 1 to be contained in the ink is from 10 to 36% by mass of the total amount of the ink. If the amount of the glycol ether is too small, the effect thereof cannot be obtained. On the other hand, if the amount of the glycol ether is too large, the nozzle is clogged with the ink and ejection becomes not easy. If the amount of the glycol ether is 35% by mass or less of the total amount of the ink, the storage stability of the aqueous inkjet ink can be maintained at a high level. It is desired that the glycol ether is used in an appropriate amount depending on the type of glycol ether or the amount of water.

In the water-soluble organic solvent, a compound as shown below may be further contained. Examples of the compound include a polyhydric alcohol having 2 to 10 carbon atoms, a lower alkyl ether of a polyhydric alcohol wherein the lower alkyl group has 1 to 6 carbon atoms and the polyhydric alcohol has 2 to 6 carbon atoms, a heterocyclic compound, and a sulfur-containing compound.

Examples of the polyhydric alcohols having 2 to 10 carbon atoms include glycerin, polyethylene glycol, polypropylene glycol, ethylene glycol, propylene glycol, triethylene glycol, 1,2-hexanediol, and trimethylolpropane.

Examples of the lower alkyl ether of a polyhydric alcohol wherein the lower alkyl group has 1 to 6 carbon atoms and the polyhydric alcohol has 2 to 6 carbon atoms include an ethylene glycol monoalkyl ether, a diethylene glycol monoalkyl ether, a triethylene glycol monobutyl ether, and a triethylene glycol monoalkyl ether.

Examples of the heterocyclic compound include 2-pyrrolidone, N-methyl-2-pyrrolidone, 1,3-dimethyl-2-imidazolidinone, and N-ethylmorpholine. Examples of the sulfur-containing compound include sulfolane, dimethylsulfoxide, and 3-sulfolene.

Further, a compound selected from diacetone alcohol, diethanolamine, and triethanolamine may be contained in the water-soluble organic solvent.

Among these compounds, glycerin, polyethylene glycol, polypropylene glycol, ethylene glycol, propylene glycol, 2-pyrrolidone, triethylene glycol monobutyl ether, and 1,2-hexanediol are preferred. These compounds also function as a moisture retaining agent.

When the aqueous inkjet ink according to this embodiment is obtained, for example, water and a water-soluble organic solvent containing a given glycol ether and a pigment dispersion are mixed. To the ink according to this embodiment, an additive as described below can be added as needed.

Since the ink according to this embodiment is for use in inkjet printing, it is necessary that the ink have a viscosity suitable for ejection from a nozzle of a head in an inkjet printer. Specifically, the viscosity of the ink at 25° C. is preferably from 5 to 30 mPa·s, more preferably from 3 to 15 mPa·s.

In order to adjust the ejection performance or the like of the aqueous inkjet ink, a surfactant may be additionally added thereto within a range that does not deteriorate the effects.

As the surfactant, either of an anionic surfactant and a nonionic surfactant may be used. Examples of the anionic surfactant include an alkylbenzene sulfonate salt, a sulfosuccinate ester salt, and a phosphate ester salt of a higher alcohol. Specific examples thereof include sodium dodecylbenzene sulfonate and sodium dioctyl sulfosuccinate.

Examples of the nonionic surfactant include a fatty acid salt, an ester salt of a higher alcohol, an ethylene oxide adduct of a higher alcohol, an ethylene oxide adduct of an alkylphenol, an ethylene oxide adduct of a polyhydric alcohol fatty acid ester, and acetylene glycol and an ethylene oxide adduct thereof. Specific examples thereof include polyoxyethylene nonylphenyl ether and polyoxyethylene lauryl ether, and also include Surfynol 104, Surfynol 440, Surfynol 465, and Surfynol TG (all of which are manufactured by Air Products and Chemicals, Inc.), and Orphin E1010 (manufactured by Nissin Chemical Industry Co., Ltd.).

If the surfactant is contained in an amount of from about 0.01 to 10% by mass of the total amount of the ink, the effect thereof can be exhibited without causing any problems. The amount of the surfactant is more preferably within a range of from 0.1 to 5% by mass of the total amount of the ink.

Among the above-described surfactants, for example, a nonionic surfactant or the like can be used as a dispersant for preparing a pigment dispersion.

In the aqueous inkjet ink according to this embodiment, an antiseptic or antifungal agent can be blended as needed. Examples of the antiseptic or antifungal agent include sodium pyridinethion-1-oxide, ethyl p-hydroxybenzoate, 1,2-benzisothiazolin-3-one and a salt thereof, sodium dehydroacetate, 2-phenoxyethanol, and sodium benzoate.

Among these, 1,2-benzisothiazolin-3-one and a salt thereof are preferred, and the compound is commercially available under the name of Proxel from Avecia Biotechnology Inc.

If the antiseptic or antifungal agent is contained in an amount of from about 0.001 to 3% by mass of the total amount of the ink, the effect thereof can be exhibited without causing any problems. The amount of the antiseptic or antifungal agent is more preferably from 0.01 to 1% by mass of the total amount of the ink.

The aqueous inkjet ink according to this embodiment preferably further contains an antioxidant. The present inventors considered the effect of the antioxidant as follows. The aqueous inkjet ink is sometimes exposed to a high temperature of 50° C. or higher when being transported. In that case, an ethylene oxide group of a glycol ether represented by the general formula 1 is cleaved and an acid is generated. Owing to the antioxidant, the generation of an acid is suppressed, and a variation in the properties of the ink such as pH due to a thermal history is suppressed. As a result, the storage stability of the ink is increased.

The above-described cleavage of an ethylene oxide group is sometimes caused when the ink is exposed to the atmosphere. When printing is performed on paper, the aqueous inkjet ink according to this embodiment is exposed to the atmosphere, the cleavage of an ethylene oxide group proceeds over time. An acid generated by the cleavage of an ethylene oxide group forms a new hydrogen bond in cellulose fiber, which results in an increase in the deformation of paper. Owing to the antioxidant, the generation of an acid is suppressed, and therefore, the formation of a new hydrogen bond is reduced. In this manner, even after some time has passed since printing is performed, the deformation of paper such as curling can be suppressed.

Examples of the antioxidant include a phenol-based antioxidant (including a hindered phenol-based antioxidant), an amine-based antioxidant, a sulfur-based antioxidant, and a phosphorus-based antioxidant.

As the phenol-based antioxidant, from the viewpoint of the weather resistance and the stability of the aqueous dispersion, 2,6-di-tert-butyl-4-methylphenol, 2,2′-methylenebis(4-ethyl-6-tert-butylphenol), tetrakis-[methylene-3-(3′,5′-di-tert-butyl-4′-hydroxyphenyl)propionate]methane, 2,6-di-tert-butyl-p-cresol (BHT), and the like are preferred.

Examples of the amine-based antioxidant include phenyl-β-naphthylamine, α-naphthylamine, N,N′-di-sec-butyl-p-phenylenediamine, phenothiazine, and N,N′-diphenyl-p-phenylenediamine.

Examples of the sulfur-based antioxidant include dilauryl 3,3′-thiodipropionate, distearyl thiodipropionate, laurylstearyl thiodipropionate, and dimyristyl 3,3′-thiodipropionate.

Examples of the phosphorus-based antioxidant include triphenyl phosphite, octadecyl phosphite, and trinonyl phenyl phosphate.

Examples of other antioxidants include ascorbic acid or an alkali metal salt thereof, a sterically hindered phenol compound such as dibutylhydroxytoluene and butylhydroxyanisole, isopropyl citrate, dl-α-tocopherol, nordihydroguaiaretic acid, and propyl gallate.

Among the above-described antioxidants, a phenol-based antioxidant and ascorbic acid or a salt thereof are preferred, and 2,6-di-tert-butyl-p-cresol (BHT) and ascorbic acid are particularly preferred.

If the antioxidant is contained in an amount of from about 0.01 to 1% by mass of the total amount of the ink, the effect thereof can be obtained without causing any problems. The amount of the antioxidant is more preferably from 0.05 to 0.5% by mass of the total amount of the ink.

To the aqueous inkjet ink according to this embodiment, an ultraviolet absorber such as a benzophenone-based, benzotriazole-based, salicylate-based, cyanoacrylate-based, or nickel complex salt-based ultraviolet absorber; a light stabilizer such as a hindered amine-based light stabilizer; an antiozonant such as a quinoline-based or phenylenediamine-based antiozonant; or the like can be further added.

The above-described additives can be used alone or in combination of two or more types thereof. By adding such an additive, the storage stability of the ink or the quality of an obtained printed image can be further increased.

Hereinafter, specific examples of the aqueous inkjet ink will be shown.

Water, a water-soluble organic solvent, a surfactant, and a color material were mixed with one another, whereby an ink sample was obtained. In the following Table 1, the contents of water and the water-soluble organic solvent in each ink sample expressed in % by mass are summarized. The remainder of each ink sample is composed of the surfactant and a pigment as the color material.

TABLE 1

| | | Water-soluble organic solvent | | | | |
|---|---|---|---|---|---|---|
| No. | Pure water | PNT-40 | TMP-30 | TMP-60 | TMP-90 | Glycerin |
| 1 | 57 | 25 | 0 | 0 | 0 | 12 |
| 2 | 57 | 10 | 0 | 0 | 0 | 27 |
| 3 | 57 | 35 | 0 | 0 | 0 | 2 |
| 4 | 57 | 9 | 0 | 0 | 0 | 28 |
| 5 | 58 | 36 | 0 | 0 | 0 | 0 |
| 6 | 50 | 25 | 0 | 0 | 0 | 19 |
| 7 | 50 | 10 | 0 | 0 | 0 | 34 |
| 8 | 50 | 35 | 0 | 0 | 0 | 9 |
| 9 | 50 | 9 | 0 | 0 | 0 | 35 |
| 10 | 50 | 36 | 0 | 0 | 0 | 8 |
| 11 | 65 | 25 | 0 | 0 | 0 | 4 |
| 12 | 65 | 10 | 0 | 0 | 0 | 19 |
| 13 | 65 | 9 | 0 | 0 | 0 | 20 |
| 14 | 57 | 0 | 25 | 0 | 0 | 12 |
| 15 | 65 | 0 | 25 | 0 | 0 | 4 |
| 16 | 50 | 0 | 25 | 0 | 0 | 19 |
| 17 | 57 | 0 | 0 | 25 | 0 | 12 |
| 18 | 65 | 0 | 0 | 25 | 0 | 4 |
| 19 | 50 | 0 | 0 | 25 | 0 | 19 |
| 20 | 57 | 0 | 0 | 0 | 25 | 12 |
| 21 | 65 | 0 | 0 | 0 | 25 | 4 |
| 22 | 50 | 0 | 0 | 0 | 25 | 19 |

As the surfactant, Surfynol 465 (manufactured by Nissin Chemical Industry Co., Ltd.) was used, and the amount thereof was set to 1% by mass of the total amount of the ink sample.

The color material was added in a state of a self-dispersible pigment dispersion. The used pigment dispersion was a carbon black dispersion liquid CAB-JET-300 (manufactured by Cabot Corporation), in which a carbon black is dispersed in water. The average particle diameter of the pigment is about 120 nm. The amount of water contained in the pigment dispersion is included in the amount of water in the above Table 1.

In the preparation of each ink sample, first, the respective components were mixed according to the formulation shown in the table, and the resulting mixture was stirred for 1 hour using a stirrer. Thereafter, the mixture was filtered through a 1-μm membrane filter, whereby the sample was obtained.

Among the water-soluble organic solvents, PNT-40, TMP-30, TMP-60, and TMP-90 are compounds represented by the following general formula 1. The relations between these compounds and the general formula 1 are summarized in the following Table 2.

TABLE 2

| | |
|---|---|
| | general formula 1 |
| 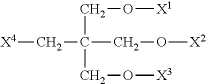 | |

| | X¹ | X² | X³ | X⁴ |
|---|---|---|---|---|
| PNT-40 | —(CH₂CH₂)OH | —(CH₂CH₂)OH | —(CH₂CH₂)OH | OH(CH₂CH₂)O— |
| TMP-30 | —(CH₂CH₂)OH | —(CH₂CH₂)OH | —(CH₂CH₂)OH | CH₃CH₂— |
| TMP-60 | —(CH₂CH₂)₂OH | —(CH₂CH₂)₂OH | —(CH₂CH₂)₂OH | CH₃CH₂— |
| TMP-90 | —(CH₂CH₂)₃OH | —(CH₂CH₂)₃OH | —(CH₂CH₂)₃OH | CH₃CH₂— |

The viscosity of each of the obtained ink samples was measured. The viscosity was measured using a cone-plate type viscometer, VISCOMETER TV-22 (manufactured by Toki Sangyo Co., Ltd.) with a cone rotor (0.8°×R24) under the condition of 25° C. and 20 rpm.

The viscosities of the respective ink samples are summarized in the following Table 3.

TABLE 3

| | Viscosity |
|---|---|
| No | (mPa · s) |
| 1 | 10.0 |
| 2 | 8.0 |
| 3 | 13.0 |
| 4 | 9.0 |
| 5 | 15.0 |
| 6 | 12.0 |
| 7 | 13.0 |
| 8 | 15.0 |
| 9 | 12.0 |
| 10 | 16.0 |
| 11 | 10.0 |
| 12 | 9.0 |
| 13 | 12.0 |
| 14 | 9.0 |
| 15 | 7.0 |
| 16 | 12.0 |
| 17 | 8.0 |
| 18 | 6.0 |
| 19 | 11.0 |
| 20 | 7.0 |
| 21 | 5.0 |
| 22 | 10.0 |

For each of the obtained ink samples, the performance of suppressing curling of paper was examined. The evaluation method was as follows.

Solid printing was performed on one surface of paper using an inkjet printing apparatus provided with a piezoelectric head CF1 manufactured by Toshiba Tec Corporation, whereby a print sample was obtained. As the paper, Toshiba Copy Paper cut to a size of 50 mm×100 mm was used. The print sample immediately after printing was placed on a flat desk, and after 1 minute, the height of each of the four corners of the print sample lifted from the surface of the desk was measured using a ruler. The curing suppressing performance immediately after printing was evaluated based on the following evaluation criteria.

A: less than 5 mm

B: 5 mm or more but less than 10 mm

C: 10 mm or more

If the height of curl is less than 10 mm, there is no problem from a practical viewpoint, and therefore, the curling suppressing performance immediately after printing can be evaluated to be favorable.

Each print sample evaluated for the curling suppressing performance immediately after printing was stored in a thermostat bath at 25° C. and 55 RH. After 3 days, the curling suppressing performance of the print sample was examined in the same manner as above. The curling suppressing performance after 3 days from printing was evaluated based on the following evaluation criteria.

A: less than 10 mm

B: 10 mm or more but less than 20 mm

C: 20 mm or more

In the evaluation of the performance after 3 days from printing, if the height of curl is less than 20 mm, there is no problem from a practical viewpoint.

Further, the presence or absence of deformation of paper immediately after printing was evaluated based on the paper conveying performance in an actual apparatus. By using an inkjet printing apparatus, a solid image was formed on Toshiba Copy Paper (A4). The inkjet printing apparatus used here was provided with a piezoelectric head CF1 manufactured by Toshiba Tec Corporation, and the conveying speed corresponded to about 50 ppm. In order to form one pixel, 3 droplets of 4 μl (picoliters) of the ink were continuously ejected from one nozzle and allowed to land on the same position. The solid image was formed at 600 dpi (dots per inch) on the entire surface of one side of the paper.

The paper conveying performance was evaluated based on the following criteria. The case where the paper can be conveyed is acceptable.

A: A paper jam is not caused and the paper can be conveyed, and the height of curl is within ±5 mm.

B: A paper jam is not caused and the paper can be conveyed, and the height of curl is within ±10 mm.

C: A paper jam is caused and the paper cannot be conveyed.

Further, the paper conveying performance was evaluated also when both-side printing was performed. In the both-side printing, the paper on which one-side printing was performed under the above-mentioned condition was automatically fed again and printing was also performed on the other side of the paper under the same condition. The paper conveying performance was evaluated based on the following criteria.

A: A paper jam is not caused and the paper can be conveyed.

B: The paper is not neatly discharged, but can be conveyed.

C: The paper cannot be conveyed due to a paper jam.

The evaluation results of the paper conveying performance are summarized in the following Table 4 along with the results of the curling suppressing performance.

TABLE 4

| | |
|---|---|
| Curling suppressing | |
| performance | Paper conveying |

| | | |
|---|---|---|
| Immediately | After 3 | performance |

| | after | days from | One-side | Both-side |
|---|---|---|---|---|
| No. | printing | printing | printing | printing |
| 1 | A | A | A | A |
| 2 | A | B | A | B |
| 3 | A | A | A | A |
| 4 | B | C | B | C |
| 5 | A | A | A | A |
| 6 | A | A | A | A |
| 7 | A | B | A | B |
| 8 | A | A | A | A |
| 9 | B | C | B | C |
| 10 | B | B | B | B |
| 11 | A | A | A | A |
| 12 | A | B | A | B |
| 13 | C | C | C | C |
| 14 | A | A | A | A |
| 15 | A | B | A | B |
| 16 | A | B | A | B |
| 17 | A | A | A | A |
| 18 | A | B | A | B |
| 19 | A | B | B | B |
| 20 | A | A | A | A |
| 21 | A | B | A | B |
| 22 | A | B | B | B |

As shown in the above Table 4, the ink samples No. 1 to No. 3, No. 5 to No. 8, No. 10 to No. 12, and No. 14 to No. 22 exhibit favorable curling suppressing performance, and also exhibit acceptable paper conveying performance. All of these ink samples contain water in an amount ranging from 50 to 70% by mass of the total amount of the ink, and also contain a water-soluble organic solvent in an amount ranging from 29 to 49% by mass of the total amount of the ink. Further, the water-soluble organic solvent contains a given glycol ether, which accounts for 10 to 36% by mass of the total amount of the ink.

In the case of the ink samples in which the amount of a given glycol ether is 35% by mass or less of the total amount of the ink, the increasing ratio of the viscosity was less than 10% even after the ink samples were stored in a thermostat bath at 65° C. for 1 week. This means that these ink samples have excellent storage stability.

All of the ink samples had favorable ejection stability. Specifically, when printing was continuously performed on 100 sheets of plain paper using the above-described inkjet printing apparatus, image defects such as a smeared image defect or a faint image defect occurred on 2 sheets or less in the case of using any ink sample.

The ink samples No. 4 and No. 9 are poor with respect to the paper conveying performance in both-side printing as well as curling suppressing performance after 3 days from printing. As shown in the above Table 1, in the ink samples No. 4 and No. 9, the amount of PNT-40 which is the glycol ether is 9% by mass of the total amount of the ink. Therefore, it is presumed that the poor performance is due to the small amount of the glycol ether.

In the case of the ink sample No. 13, all of the properties were evaluated as “C”. In the ink sample No. 13, although the amount of PNT-40 is the same as that of the ink samples No. 4 and No. 9, the amount of water is large. Therefore, in the case of the ink sample No. 13, the desired properties cannot be obtained.

In order to obtain an aqueous inkjet ink with which an image can be formed while suppressing the deformation of paper, the ink should contain water in an amount of from 50 to 70% by mass of the total amount of the ink and a water-soluble organic solvent in an amount of from 29 to 49% by mass of the total amount of the ink. Further, it is necessary that the compound represented by the general formula 1 account for 10 to 36% by mass of the total amount of the ink. Since the ink samples No. 1 to No. 3, No. 5 to No. 8, No. 10 to No. 12, and No. 14 to No. 22 satisfied all the requirements, the desired properties were obtained.

The aqueous inkjet ink according to this embodiment can form an image on a paper medium without causing the deformation of the paper medium such as curling.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying aims and their equivalents are intended to cover such forms or modifications as would fall within the scope and spirit of the inventions.

What is claimed is:

1. An aqueous inkjet ink comprising:
a color material;
water in an amount of from 50 to 70% by mass of a total amount of the aqueous inkjet ink; and
a water-soluble organic solvent in an amount of from 29 to 49% by mass of the total amount of the aqueous inkjet ink, the water-soluble organic solvent comprising a compound represented by the following general formula 1, the compound represented by the following general formula 1 accounting for 10 to 36% by mass of the total amount of the aqueous inkjet ink, and if the amount of the compound represented by the following general formula 1 is equal to the amount of the water-soluble organic solvent, the total amount of the water-soluble organic solvent is the compound represented by the following general formula 1, and the sum of the amounts of the color material, the water, and the water-soluble organic solvent being 100% by mass or less of the aqueous inkjet ink: 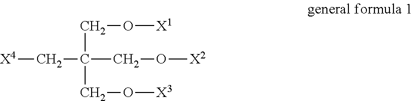
wherein, X¹, X², and X³ each independently represent EOn; and X⁴ represents an ethyl group or an (EOn)O group, wherein EOn is represented by the following general formula 2:
CH₂—CH₂ₙOH general formula 2
wherein n represents an integer of 1 to 5.

2. The ink according to claim 1, wherein the amount of the compound represented by the general formula 1 is 35% by mass or less of the total amount of the aqueous inkjet ink.

3. The ink according to claim 1, wherein n in the general formula 2 is from 1 to 2.

4. The ink according to claim 1, wherein the aqueous inkjet ink has a viscosity at 25° C. of from 5 to 30 mPa·s.

5. The ink according to claim 1, wherein the color material is a pigment.

6. The ink according to claim 5, wherein the pigment is a self-dispersible pigment.

7. The ink according to claim 5, wherein an amount of the pigment is from 1 to 20% by mass of the total amount of the aqueous inkjet ink.

8. The ink according to claim 1, wherein the water-soluble organic solvent further comprises a moisture retaining agent.

9. The ink according to claim 8, wherein the moisture retaining agent is selected from glycerin and polyethylene glycol.

10. The ink according to claim 1, further comprising a surfactant.

11. The ink according to claim 10, wherein an amount of the surfactant is from 0.01 to 10.0% by mass of the total amount of the aqueous inkjet ink.

12. The ink according to claim 10, wherein the surfactant is an acetylene glycol-based surfactant.

13. The ink according to claim 1, further comprising an antioxidant.

14. The ink according to claim 13, wherein the antioxidant is selected from the group consisting of 2,6-di-tert-butyl-4-methylphenol, 2,2′-methylenebis(4-ethyl-6-tert-butylphenol), tetrakis-[methylene-3-(3′,5′-di-tert-butyl-4′-hydroxyphenyl)propionate]methane, 2,6-di-tert-butyl-p-cresol, and ascorbic acid.

15. A method for inkjet printing comprising:
conveying a paper medium in the direction of an inkjet head;
ejecting an aqueous inkjet ink onto the paper medium, thereby forming an image; and
discharging the paper medium having the image formed thereon, wherein
the aqueous inkjet ink comprises:
a color material;
water in an amount of from 50 to 70% by mass of the total amount of the aqueous inkjet ink; and
a water-soluble organic solvent in an amount of from 29 to 49% by mass of the total amount of the aqueous inkjet ink, the water-soluble organic solvent comprising a compound represented by the following general formula 1, and the compound represented by the following general formula 1 accounting for 10 to 36% by mass of the total amount of the aqueous inkjet ink, and if the amount of the compound represented by the following general formula 1 is equal to the amount of the water-soluble organic solvent, the total amount of the water-soluble organic solvent is the compound represented by the following general formula 1, and the sum of the amounts of the color material, the water, and the water-soluble organic solvent being 100% by mass or less of the aqueous inkjet ink: 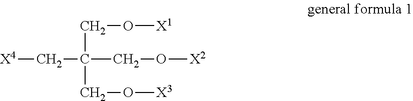
wherein, X¹, X², and X³ each independently represent EOn; and X⁴ represents an ethyl group or an (EOn)O group, wherein EOn is represented by the following general formula 2:
CH₂—CH₂ₙOH general formula 2
wherein n represents an integer of 1 to 5.

16. The method according to claim 15, wherein the formation of an image is performed using one type of inkjet ink.

17. The method according to claim 15, wherein the formation of an image is performed using two or more types of inkjet inks of different colors.

18. The method according to claim 15, wherein the paper medium is conveyed at a speed of 50 ppm or more.

19. An inkjet printing apparatus comprising:
a conveying roller which conveys a paper medium in the direction of an inkjet head;
an inkjet head which ejects an aqueous inkjet ink onto the paper medium; and
a discharging roller which discharges the paper medium, wherein
the aqueous inkjet ink comprises:
a color material;
water in an amount of from 50 to 70% by mass of the total amount of the aqueous inkjet ink; and
a water-soluble organic solvent in an amount of from 29 to 49% by mass of the total amount of the aqueous inkjet ink, the water-soluble organic solvent comprising a compound represented by the following general formula 1, and the compound represented by the following general formula 1 accounting for 10 to 36% by mass of the total amount of the aqueous inkjet ink, and if the amount of the compound represented by the following general formula 1 is equal to the amount of the water-soluble organic solvent, the total amount of the water-soluble organic solvent is the compound represented by the following general formula 1, and the sum of the amounts of the color material, the water, and the water-soluble organic solvent being 100% by mass or less of the aqueous inkjet ink: 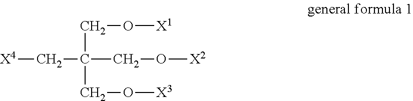
wherein, X¹, X², and X³ each independently represent EOn; and X⁴ represents an ethyl group or an (EOn)O group, wherein EOn is represented by the following general formula 2:
CH₂—CH₂ₙOH general formula 2
wherein n represents an integer of 1 to 5.

20. The apparatus according to claim 19, wherein the conveying roller conveys the paper medium at a speed of 50 ppm or more.
